(19) United States
(12) Patent Application Publication
(10) Pub. No.: US 2021/0206919 A1
(43) Pub. Date: Jul. 8, 2021

(54) PROCESS FOR PREPARING POLYAMIDE POWDERS BY PRECIPITATION

(71) Applicant: BASF SE, Ludwigshafen am Rhein (DE)

(72) Inventors: Angela ULZHÖFER, Ludwigshafen am Rhein (DE); Simon GRAMLICH, Ludwigshafen am Rhein (DE); Rainer OSTERMANN, Recklinghause (DE); Achim STAMMER, Ludwigshafen am Rhein (DE); Dirk SIMON, Mannheim (DE); Ning ZHU, Ludwigshafen am Rhein (DE)

(21) Appl. No.: 15/999,520

(22) PCT Filed: Feb. 16, 2017
(86) PCT No.: PCT/EP2017/053491

§ 371 Date: Aug. 17, 2018

(30) Foreign Application Priority Data
Feb. 19, 2016 (DE) 16156540.3

(51) Int. Cl. C08G 69/04; C08G 69/16; C08G 69/46; C08J 3/07; C08J 3/14; C08L 77/02

(52) U.S. Cl. CPC C08G 69/04; C08G 69/16; C08G 69/46; C08J 2377/02; C08J 3/14; C08L 77/02; C08J 3/07

(57) ABSTRACT

Process for producing polyamide powders by precipitation The present invention relates to a process for producing polyamide powders and to the polyamide powders obtainable by this process. The present invention additionally relates to the use of the polyamide powder as sintering powder in selective laser sintering.

The present invention relates to a process for producing polyamide powders and to the polyamide powders obtainable by this process.

Polyamides are notable for high chemicals resistance and for very good mechanical properties. The use of pulverulent coating media based on polyamides for producing paint-like metals coverings is known. Coating is effected here for example by fluidized-bed sintering processes, flame spray processes or by electrostatic coating processes.

Preference is given here to polyamide powders having a narrow grain size distribution, a round shape and a smooth surface. Polyamide powders having the aforementioned properties are readily fluidizable and thus particularly well-suited for coating processes.

The polyamide powders described hereinabove are typically produced by precipitation processes.

DE 29 06 647 describes a process for producing coating powders based on polyamides having at least 10 aliphatically bonded carbon atoms per carboamide group. To produce the polyamide powder the polyamides are dissolved in ethanol under pressure at temperatures in the range from 130 to 150° C. This solution is then cooled to temperatures in the range from 100 to 125° C. to precipitate out the polyamide in powder form. The polyamide powder is subsequently filtered off and dried. The polyamide powders obtainable by the process according to DE 29 06 647 have a relatively wide grain size distribution in the range from 40 to 250 μm.

DE 1 494 563 describes a process for producing polyamide powders colored with pigments. Polyamides described in DE 1 494 563 are polyamides made of ε-caprolactam, of w-aminoundecanoic acid and also polyamides made of hexamethylenediamine and adipic acid. To produce the colored polyamide powders the polyamide is dissolved in an organic solvent together with a pigment dispersion. To this end, the mixture is heated to temperatures of >100° C. The thus obtained solution is subsequently cooled to precipitate out the polyamide together with the pigment as a powder. The colored polyamide powder is subsequently filtered off and dried. The process described in DE 1 494 563 also affords polyamide powders having a relatively wide grain size distribution.

EP 0 863 174 likewise describes a process for producing polyamide powders by precipitation processes. Polyam ides made of lactams/w-aminocarboxylic acids having at least 10 carbon atoms are employed as the polyamide component. These polyamides are dissolved under pressure in aliphatic alcohol having 1 to 3 carbon atoms. To this end, the solution is heated under pressure to 130 to 165° C. This solution is then initially cooled to a so-called nucleation temperature and held at this temperature for 10 minutes to 2 hours. The solution is subsequently cooled further to precipitate out the polyamide powder. The polyamide powder is subsequently filtered off and dried. Polyamide powders having a relatively narrow grain size distribution are obtained by the process according to EP 0 863 174. One disadvantage, inter alia, of the process according to EP 0 863 174 is that very high pressures are required to achieve the temperatures in the range from 130 to 165° C. when employing alcohols as solvents. This renders the process according to EP 0 863 174 complex and thus costly.

CH 549 622 describes a process for producing polymer powders where a polymer, for example polyamide, is melted in an organic solvent which is solid at 25° C. The resulting melt is then poured out to solidify the melt. The thus obtained solid is subsequently ground and the obtained powder sifted. In a further process step the solid-at-25° C. organic solvent is extracted from this powder to obtain the polymer powder. The process according to CH 549 622 is very complex since a multiplicity of process steps is necessary to produce the polymer powder, inter alia melting, solidification, production of a powder by a grinding process, sifting of the powder, subsequent extraction of the solid-at-25° C. organic solvent and drying. The process described in CH 549 622 is therefore exceptionally technically complex and costly.

DE 1 089 929 describes a process for producing polyamide powders for application in cosmetics and medical powders. The polyamides employed are preferably polycaprolactams. The polyamides are subsequently heated in a carbamyl compound to obtain a clear solution of the polyamide in the carbamyl compound. Preferred carbamyl compounds are aliphatic compounds substituted with alkyl groups at the nitrogen atom. Particular preference is given to dimethylformamide, dimethylacetamide, diethylacetamide and acetamide. Also described, as a cyclic carbamyl compound, is pyrrolidone. DE 1 089 929 describes two alternatives for precipitating the polyamide out of the clear solution. Firstly, it is possible to produce the polyamide powders by cooling the clear solution. As a second alternative DE 1 089 929 describes addition of water to the clear solution to precipitate out the polyamide powder. To remove the polyamide powder after the precipitation said powder is removed from the solution and dried. The polyamide powders according to DE 1 089 929 are suitable in particular for application in cosmetic and medical powders. The obtained polyamide powders have a grain size distribution in the range from 1 to 25 μm.

U.S. Pat. No. 3,446,782 likewise describes a process for producing polyamide powders. To produce the polyamide powder an aqueous solution of a lactam is initially charged and the polyamide subsequently added. The thus obtained mixture is subsequently heated in an autoclave with stirring. The temperature is chosen here such that it is above the softening point of the polyamide and below the melting point of the polyamide. The concentration of the lactam in the aqueous solution is in the range from 10 to 95 wt % based on the total weight of the aqueous solution. After addition of the polyamide to the aqueous solution a dispersion of the polyamide in the aqueous solution is obtained by stirring and heating. This dispersion is subsequently cooled and the obtained polyamide powder is filtered off and optionally washed with water. The high temperatures described in the process according to U.S. Pat. No. 3,446,782 can result in molecular weight loss of the employed polyamide.

The present invention accordingly has for its object the provision of a process for producing polyamide powders where the above-described disadvantages of the prior art are absent or much reduced. The process shall be performable easily and cost-effectively and shall provide polyamide powders having a narrow grain size distribution and spherical geometry. The process shall additionally reduce the formation of fine fraction/coarse fraction compared to the process described in the prior art.

This object is achieved by a process for producing polyamide powder comprising the process steps of
a) heating a mixture comprising a polyamide and a lactam to a temperature greater than a cloud temperature (T_{Cl}) above which the polyamide is fully dissolved in the lactam to obtain a melt which comprises the polyamide fully dissolved in the lactam,
b) cooling the melt obtained in process step a) to a temperature lower than or equal to the cloud temperature (T_{Cl}) and subsequently adding water to obtain a suspension comprising the polyamide powder suspended in a solution comprising water and the lactam, and
c) removing the polyamide powder from the suspension obtained in process step b).

The process according to the invention affords polyamide powders having a narrow grain size distribution. The particles of the polyamide powders additionally exhibit a round shape (sphericity). The process according to the invention markedly reduces the formation of fine fraction and coarse fraction in the polyamide powder compared to the process described in the prior art.

Polyamide

The polyamide employed may be precisely one polyamide. It is also possible to use mixtures of two or more polyamides. It is preferable to employ precisely one polyamide.

Suitable polyamides generally have a viscosity number of 70 to 350, preferably of 70 to 240, ml/g. The viscosity number is determined according to the invention from a 0.5 wt % solution of the polyamide in 96 wt % sulfuric acid at 25° C. according to ISO 307.

Preferred polyamides are semicrystalline or amorphous polyamides. Suitable polyamides have a weight-average molecular weight (M_{w}) in the range from 500 to 2 000 000 g/mol, preferably in the range from 5 000 to 500 000 g/mol and particularly preferably in the range from 10 000 to 100 000 g/mol. The weight-average molecular weight (M_{w}) is determined according to ASTM D4001.

Suitable polyamides include for example polyamides which derive from lactams having 7 to 13 ring members. Suitable polyamides further include polyamides obtained by reaction of dicarboxylic acids with diamines.

Examples of polyamides which derive from lactams include those which derive from polycaprolactam, polycaprylolactam and/or polylaurolactam.

Suitable polyamides further include those obtainable from co-aminoalkyl nitriles. A preferred co-aminoalkyl nitrile is aminocapronitrile which affords polyamide 6. Furthermore, dinitriles may be reacted with diamine. Preference is given here to adipodinitrile and hexamethylenediamine which polymerize to afford polyamide 66. The polymerization of nitriles is effected in the presence of water and is also known as direct polymerization.

When polyamides obtainable from dicarboxylic acids and diamines are used, dicarboxylic acid alkanes (aliphatic dicarboxylic acids) having 6 to 36 carbon atoms, preferably 6 to 12 carbon atoms and particularly preferably 6 to 10 carbon atoms may be employed. Aromatic dicarboxylic acids are also suitable.

Examples of dicarboxylic acids include adipic acid, azelaic acid, sebacic acid, dodecanedioic acid and also terephthalic acid and/or isophthalic acid.

Suitable diamines include for example alkanediamines having 4 to 36 carbon atoms, preferably alkanediamines having 6 to 12 carbon atoms, in particular alkanediamines having 6 to 8 carbon atoms, and aromatic diamines, for example m-xylylenediamine, di(4-aminophenyl)methane, di(4-aminocyclohexyl)methane, 2,2-di(4-aminophenyl)propane and 2,2-di(4-aminocyclohexyl)propane and also 1,5-diamino-2-methylpentane.

Preferred polyamides are polyhexamethylene adipamide, polyhexamethylene sebacamide and polycaprolactam and also copolyamide 6/66, in particular having a proportion of caprolactam units of 5 to 95 wt %.

Also suitable are polyamides obtainable by copolymerization of two or more of the monomers mentioned hereinabove and hereinbelow or mixtures of a plurality of polyamides in any desired mixing ratio. Particularly preferred mixtures are mixtures of polyamide 66 with other polyamides, in particular copolyamide 6/66.

Suitable polyamides are accordingly aliphatic, semiaromatic or aromatic polyamides. The term “aliphatic polyamides” is to be understood as meaning that the polyamides are constructed exclusively of aliphatic monomers. The term “semiaromatic polyamides” is to be understood as meaning that the polyamides are constructed of both aliphatic and aromatic monomers. The term “aromatic polyamides” is to be understood as meaning that the polyamides are constructed exclusively from aromatic monomers.

The nonexhaustive list which follows contains the aforementioned, and further, polyamides suitable for use in the process according to the invention and also the monomers present.

AB polymers:

PA 4 pyrrolidone

PA 6 ε-caprolactam

PA 7 enantholactam

PA 8 caprylolactam

PA 9 9-aminopelargonic acid

PA 11 11-aminoundecanoic acid

PA 12 laurolactam

AA/BB polymers:

PA 46 tetramethylenediamine, adipic acid

PA 66 hexamethylenediamine, adipic acid

PA 69 hexamethylenediamine, azelaic acid

PA 610 hexamethylenediamine, sebacic acid

PA 612 hexamethylenediamine, decanedicarboxylic acid

PA 613 hexamethylenediamine, undecanedicarboxylic acid

PA 1212 dodecane-1,12-diamine, decanedicarboxylic acid

PA 1313 tridecane-1,13-diamine, undecanedicarboxylic acid

PA 6T hexamethylenediamine, terephthalic acid

PA 9T nonyldiamine, terephthalic acid

PA MXD6 m-xylylenediamine, adipic acid

PA 6I hexamethylenediamine, isophthalic acid

PA 6-3-T trimethylhexamethylenediamine, terephthalic acid

PA 6/6T (see PA 6 and PA 6T)

PA 6/66 (see PA 6 and PA 66)

PA 6/12 (see PA 6 and PA 12)

PA 66/6/610 (see PA 66, PA 6 and PA 610)

PA 6I/6T (see PA 6I and PA 6T)

PA PACM 12 diaminodicyclohexylmethane, laurolactam

PA 6I/6T/PACM as PA 6I/6T and diaminodicyclohexylmethane

PA 12/MACMI laurolactam, dimethyldiaminodicyclohexylmethane, isophthalic acid

PA 12/MACMT laurolactam, dimethyldiaminodicyclohexylmethane, terephthalic acid

PA PDA-T phenylenediamine, terephthalic acid

The present invention thus also provides a process where the polyamide is at least one polyamide selected from the group consisting of PA 4, PA 6, PA 7, PA 8, PA 9, PA 11, PA 12, PA 46, PA 66, PA 69, PA 610, PA 612, PA 613, PA 1212, PA1313, PA 6T, PA MXD6, PA 6I, PA 6-3-T, PA 6/6T, PA 6/66, PA 6/12, PA 66/6/610, PA 6I/6 T, PA PACM 12, PA 6I/6T/PACM, PA 12/MACMI, PA 12/MACMT, PA PDA-T and copolyamides composed of two or more of the aforementioned polyamides.

It is preferable when the polyamide is at least one polyamide selected from the group consisting of polyamide 6 (PA 6), polyamide 66 (PA 66), polyamide 610 (PA 610) and polyamide 6/6T (PA 6/6T).

Particularly preferred polyamides are polyamide 6 (PA 6) and/or polyamide 66 (PA 66), polyamide 6 (PA 6) being especially preferred.

Lactam

In accordance with the invention the term “lactam” is to be understood as meaning cyclic amides having 3 to 12 carbon atoms, preferably 4 to 6 carbon atoms, in the ring. Suitable lactams are for example selected from the group consisting of 3-aminopropanolactam (β-lactam; β-propiolactam), 4-aminobutanolactam (γ-lactam; γ-butyrolactam), 5-aminopentanolactam (δ-lactam; δ-valerolactam), 6-aminohexanolactam (ε-lactam; ε-caprolactam), 7-aminoheptanolactam (ζ-lactam; ζ-heptanolactam), 8-aminooctanolactam, 9-nonanolactam (θ-lactam; θ-nonanolactam), 10-decanolactam (ω-decanolactam), 11-undecanolactam (ω-undecanolactam), and 12-dodecanolactam (ω-dodecanolactam).

The present invention thus also provides a process where the lactam is selected from the group consisting of 3-aminopropanolactam, 4-aminobutanolactam, 5-aminopentanolactam, 6-aminohexanolactam, 7-aminoheptanolactam, 8-aminooctanolactam, 9-nonanolactam, 10-decanolactam, 11-undecanolactam, and 12-dodecanolactam.

The lactams may be unsubstituted or at least monosubstituted. If at least monosubstituted lactams are used, the nitrogen atom and/or the ring carbon atoms thereof may bear one, two, or more substituents selected independently of one another from the group consisting of C₁- to C₁₀-alkyl, C₅- to C₆-cycloalkyl, and C₅- to C₁₀-aryl.

Suitable C₁- to C₁₀-alkyl substituents include for example methane, ethane, propyl, isopropyl, n-butyl, sec-butyl, and tert-butyl. Suitable C₅-bis C₆-cycloalkyl substituents are cyclohexyl. Preferred C₅- to C₁₀-aryl substituents are phenyl and anthranyl.

Preference is given to using unsubstituted lactams, γ-lactam (γ-butyrolactam), δ-lactam (δ-valerolactam) and ε-lactam (ε-caprolactam) being preferred. Particular preference is given to δ-lactam (δ-valerolactam) and ε-lactam (ε-caprolactam), ε-caprolactam being especially preferred.

Process Step a)

In process step a) a mixture comprising a polyamide and a lactam is heated to temperatures greater than a cloud temperature (T_{Cl}) above which the polyamide is fully dissolved in the lactam. It is thus immaterial for process step a) whether the polyamide and the lactam are provided together or added successively. It is possible to initially heat the polyamide and subsequently add the lactam. It is moreover also possible to heat the lactam and the polyamide together. However, it is preferable to initially heat the lactam and subsequently add the polyamide.

Above the cloud temperature (T_{Cl}), the polyamide is fully dissolved in the molten lactam. Expressed another way, this means that an optically clear solution of the polyamide in the molten lactam is obtained. In this solution the melt of the lactam forms the solvent and the polyamide forms the solvate. Above the cloud temperature (T_{Cl}) the polyamide molecules are homogeneously and randomly distributed in the molten lactam and cannot be removed by filtration. Above the cloud temperature (T_{Cl}) the polyamide and the lactam are thus in the form of an optically clear solution, wherein the polyamide molecules are homogeneously and randomly distributed in the lactam.

In the process according to the invention the cloud temperature (T_{Cl}) depends on the type of the lactam, the type of the polyamide and the concentration of the polyamide in the melt produced in process step a).

In process step a) the mixture which comprises the polyamide and the lactam is generally heated to temperatures in the range from 170° C. to 250° C., preferably to temperatures in the range from 170° C. to 230° C., particularly preferably to temperatures from 170° C. to 210° C. and in particular to temperatures in the range from 180° C. bis 200° C.

In a further embodiment the mixture is heated to a temperature at least 10° C. below the melting temperature of the employed polyamide in process step a). It is particularly preferable when the mixture is heated to a temperature in the range from 10° C. to 50° C. below the melting temperature of the employed polyamide, more preferably to a temperature in the range from 10° C. to 35° C. below the melting temperature of the employed polyamide and in particular to a temperature in the range from 10° C. to 20° C. below the melting temperature of the employed polyamide in process step a).

The melting temperature of the polyamide employed in process step a) is defined here as the temperature at which the polyamide as a pure substance is at least partly converted from the solid state of matter to the liquid state of matter. The melting temperature of the polyamide is determined by differential scanning calorimetry.

The present invention thus also provides a process where in process step a) the mixture is heated to a temperature in the range from 170° C. to 250° C. to obtain the melt.

As a result of this the lactam present in the mixture melts and the polyamide fully dissolves in the molten lactam.

The melt produced in process step a) which comprises the polyamide fully dissolved in the lactam generally comprises less than 5 wt % of water, preferably less than 4 wt % of water, particularly preferably less than 2 wt % of water and especially preferably less than 1 wt % of water in each case based on the total weight of the melt present in process step a) which comprises the polyamide fully dissolved in the lactam.

The lower limit of the water content of the melt obtained in process step a) is generally in the range from 0 to 0.5 wt %, preferably in the range from 0 to 0.3 wt %, particularly preferably in the range from 0 to 0.1 wt % in each case based on the total weight of the melt obtained in step a).

The present invention thus also provides a process where the water content of the melt obtained in process step a) is in the range from 0 to less than 5 wt % based on the total weight of the melt obtained in process step a).

The water content of the employed polyamide and the water content of the employed lactam have a determining influence on the water content of the melt obtained in process step a).

The water content of the employed polyamide is generally in the range from 0 to <2.5 wt %, preferably in the range from 0 to 2 wt % and particularly preferably in the range from 0 to 1 wt % in each case based on the total weight of the polyamide employed in process step a). The lower limit of the water content of the polyamide employed in process step a) is generally in the range from 0 to 0.5 wt %, preferably in the range from 0 to 0.2 wt %.

The water content of the lactam employed in process step a) is generally in the range from 0 to <5 wt %, preferably in the range from 0 to <4 wt %, particularly preferably in the range from 0 to 2 wt % and especially preferably in the range from 0 to 1 wt % in each case based on the total weight of the lactam employed in process step a).

The lower limit of the water content of the lactam employed in process step a) is generally in the range from 0 to 0.5 wt %, preferably in the range from 0 to 0.2 wt %, in each case based on the total weight of the melt obtained in step a).

The water content of the polyamide employed in process step a) and the water content of the lactam employed in process step a) is generally chosen such that melt obtained in process step a) has the aforementioned water content, the preceding remarks and preferences applying correspondingly thereto.

The mixture of lactam and polyamide employed in process step a) and the melt obtained in process step a) are thus substantially water-free. This has the advantage that the melt formed in process step a) is a real solution of the polyamide in the lactam. The formation of a dispersion or emulsion of the polyamide in the lactam is thus prevented in process step a).

The polyamide is employed in process step a) in amounts such that the melt obtained in process step a) comprises the polyamide in amounts in the range from 5 to 60 wt %, preferably in the range from 8 to 50 wt % and particularly preferably in the range from 10 to 30 wt % in each case based on the total weight of the melt obtained in step a) which comprises the polyamide fully dissolved in the lactam.

The present invention thus also provides a process where the melt obtained in process step a) comprises the polyamide in amounts in the range from 5 to 60 wt % based on the total weight of the melt obtained in process step a).

In addition to the polyamide and the lactam, further additives may optionally be added in process step a). The point in time of the addition of additives is immaterial here. The additives may be initially charged together with the polyamide and the lactam. It is further possible to add the additives to the melt obtained in process step a). It is also possible to initially charge the additive(s) together with the polyamide or together with the lactam. It is further possible to employ a polyamide which already comprises additives.

Preferred additives are anti-nucleation agents. Preferred anti-nucleation agents are selected from the group consisting of lithium chloride, nigrosine, methylene blue and neutral red. A preferred anti-nucleation agent is nigrosine. Nigrosine is a synthetic black dye also known as “Solvent Black 5” (Colour Index 50415). Nigrosine may be produced for example by heating nitrobenzene and aniline and aniline hydrochloride in the presence of copper or iron.

Methylene blue is a dye also known as N,N,N′,N′-tetramethylenethionine chloride or Basic Blue 9 (Colour Index 52015; CAS number 61-73-4/122965-43-9).

Neutral red is a dye also known as 3-amino-7-dimethylamino-2-methylphenazine hydrochloride or tolylene red (Colour Index 50040: CAS number 553-24-2).

The additives, preferably the anti-nucleation agents, are added in process step a) generally in amounts such that the polyamide powder obtained according to process step c) has an additive content in the range from 0 to 3 wt %, preferably in the range from 0.5 to 2.5 wt %, particularly preferably in the range from 0.5 to 2 wt %, in particular in the range from 1 to 2 wt %, in each case based on the total weight of the polyamide powder obtained by process step c).

The present invention thus also provides a process where the melt present in process step a) comprises at least one anti-nucleation agent selected from the group consisting of lithium chloride, nigrosine, methylene blue and neutral red.

The present invention thus further also provides a process where the anti-nucleation agent is added in process step a) in amounts such that the polyamide powder obtained according to process step c) comprises the anti-nucleation agent in amounts in the range from 0.1 to 3 wt % based on the total weight of the polyamide obtained according to process step c).

In a preferred embodiment process step a) is performed under a protective gas atmosphere. An employable protective gas in this case is nitrogen for example. Process step a) may be performed under atmospheric pressure but it is preferable when process step a) is performed under pressure. The pressure during process step a) is generally in the range from 0.5 to 10 bar abs.

Process step a) is preferably performed with agitation. Suitable apparatuses for performing process step a) to obtain the melt which comprises the polyamide fully dissolved in the lactam are known to those skilled in the art. Suitable apparatuses are for example reactors which comprise a stirring means and which are able to be pressurized. Suitable stirring means are for example anchor stirrers.

Process Step b)

In process step b) the melt obtained in process step a) is cooled to a temperature 5 the cloud temperature (T_{Cl}). It is preferable when the melt obtained in process step a) is cooled to a temperature at least 0.5° C., preferably at least 1° C., below the cloud temperature (T_{Cl}). Upon reaching or going below the cloud temperature (T_{Cl}) the melt undergoes clouding, i.e. is no longer optically clear. The clouding may be discerned by purely visual means with the naked eye. It is also possible to determine the reaching or going below the cloud temperature (T_{Cl}) by transmission measurement.

The reference value used here is the transmission of the melt produced in process step a) which comprises the polyamide fully dissolved in the lactam. The transmission of the melt obtained in process step a) is defined here as 100% and subsequently used as a reference value.

Reaching or going below the cloud temperature (T_{Cl}) by virtue of the cooling in process step b) causes the transmission to fall. Generally upon reaching or going below the cloud temperature (T_{Cl}) during cooling in process step b) the transmission of the melt falls by at least 5%, preferably by at least 20%, particularly preferably by at least 30%, based on the transmission of the melt obtained in process step a) which comprises the polyamide fully dissolved in the lactam (transmission 100%).

Expressed another way, this means that in process step b), i.e. upon reaching or going below the cloud temperature (T_{Cl}) and before addition of the water, upon reaching or going below the cloud temperature (T_{Cl}), the melt has a transmission of not more than 95%, preferably of not more than 80% and particularly preferably of not more than 70% based on the transmission of the melt obtained in process step a) (100% transmission).

After reaching or going below the cloud temperature (T_{Cl}) water is added in process step b) to obtain a suspension which comprises the polyamide powder suspended in a water- and lactam-comprising solution.

In addition to water, further solvents such as alcohol for example may also be added in process step b). Suitable further solvents are for example methanol, ethanol, n-propanol or isopropanol. If further solvents are added in process step b) these may be added before or after the addition of water. It is moreover possible to add a mixture comprising water and at least one further solvent in process step b). According to the invention it is necessary only for water to be added in process step b). In a preferred embodiment only water is added in process step b).

According to the invention the addition of water may be added before or after solidification of the melt. If the water is added after solidification of the melt, the water dissolves the lactam to obtain the suspension of the polyamide powder. In a preferred embodiment the addition of water in process step b) is effected before solidification of the melt.

The cloud temperature (T_{Cl}) thus forms the upper temperature limit at which water may be added in process step b). The lower temperature limit down to which water may be added in process step b) is generally the melting temperature (T_{M}) (melting point) of the lactam employed in the process according to the invention. According to the invention the melting point is measured at a pressure of 1.01325 bar. According to the invention the melting temperature (T_{M}) is identical to the melting point of the lactam.

The present invention thus also provides a process where the lactam has a melting temperature (T_{M}) and the melt obtained in process step a) is cooled in process step b) to a temperature in the range from equal to the cloud temperature (T_{Cl}) to greater than the melting temperature (T_{M}) of the lactam and water is subsequently added.

If the lactam employed is ε-caprolactam the lower limit before which water must be added is accordingly 68° C. If the lactam employed is δ-valerolactam the lower limit above which water must be added in process step b) is accordingly 40° C.

As already intimated hereinabove the cloud temperature (T_{Cl}) depends on the properties of the polyamide and of the lactam and also on the concentration of the polyamide in the melt. Suitable temperature ranges within which the addition of water according to process step b) may be effected are generally in the range from 80 to <170° C., preferably in the range from 90 to 160° C., particularly preferably in the range from 100 to 150° C. and in particular in the range from 120 to 145° C., wherein the addition of water is-effected only after reaching or going below the cloud temperature (T_{Cl}).

In a particularly preferred embodiment the addition of water in process step b) is effected in a temperature range having an upper limit equal to the cloud temperature (T_{Cl}) and a lower limit defined by a temperature not more than 20° C. below the crystallization temperature (T_{Cr}) of the employed polyamide.

The present invention thus also provides a process where the polyamide has a crystallization temperature (T_{Cr}) and the melt obtained in process step a) is cooled in process step b) to a temperature in the range from equal to the cloud temperature (T_{Cl}) to not more than 20° C. below the crystallization temperature (T_{Cr}) of the polyamide and water is subsequently added.

Polyamides are generally semicrystalline. The degree of crystallization of polyamides is generally in the range from 20% to 50%. The degree of crystallization is also known as crystallinity or degree of crystallinity. Heating the mixture according to process step a) forms a melt which comprises the polyamide fully dissolved in the lactam. The crystalline regions of the polyamide dissolve during formation of the melt in process step a). The polyamide is moreover converted from the form of a solid into the state of matter of a solution. This causes the polyamide to absorb heat (energy). This heat is also known of as latent heat. The latent heat here is composed of the enthalpy that must be expended to dissolve crystalline regions and of the enthalpy required for the conversion from the solid to the solution. The two enthalpies are known as enthalpy of crystallization and enthalpy of solution.

When cooling the melt obtained in process step a) it is the cloud temperature (T_{Cl}) that is initially attained in process step b). The cloud temperature (T_{Cl}) is distinct from the crystallization temperature (T_{Cr}). The crystallization temperature (T_{Cr}) is generally below the cloud temperature (T_{Cl}). Upon reaching the crystallization temperature (T_{Cr}) the polyamide is fully converted from the solution into the solid state of matter and the crystalline regions reform. The heat absorbed by the polyamide in process step a) (latent heat) is thus released again in process step b). The onset of crystallization, i.e. the attainment of the crystallization temperature (T_{Cr}), may therefore be detected by a temperature increase.

In accordance with the invention the term “crystallization temperature (T_{Cr})” is accordingly to be understood as meaning the temperature at which the polyamide releases the latent heat absorbed in process step a), i.e. the sum of the enthalpy of solution and the entropy of crystallization, to the surroundings.

The crystallization temperature (T_{K}) may for example be determined via a resistance thermometer (PT100) or a thermocouple combined with a torque measurement. The torque shows a marked change in gradient at the crystallization temperature (T_{Cr}), the torque increases markedly while in the cooling phase it increases only slightly due to the viscosity increase of the continuous phase.

In a further embodiment the crystallization temperature (T_{Cr}) is determined via a temperature sensor which is located in the reactor and measures the temperature of the melt in process step b). The crystallization temperature (T_{Cr}) may accordingly be detected by a temperature increase in the melt in process step b).

In a preferred embodiment of the process according to the invention the addition of water in process step b) is effected above a temperature which is not more than 20° C., preferably not more than 10° C., particularly preferably not more than 5° C. and especially preferably not more than 2° C. below the crystallization temperature (Tar) of the employed polyamide.

The crystallization temperature (T_{Cr}) also depends on the properties of the polyamide and of the lactam and also on the concentration of the polyamide in the melt.

The amount of the water added in process step b) may be varied over wide limits. Generally at least one part by weight of water, preferably at least 2 parts by weight of water, particularly preferably at least 3 parts by weight of water and in particular at least 5 parts by weight of water are added in process step b) based on one part by weight of the polyamide present in the melt/the at least partly solidified melt.

Generally not more than 20 parts by weight of water, preferably not more than 15 parts by weight of water, particularly preferably not more than 10 parts by weight of water and in particular not more than 8 parts by weight of water are added in each case based on one part by weight of the polyamide present in the melt/the at least partly solidified melt. It will be appreciated that it is also possible to add larger amounts of water. However, this does not achieve any advantageous effect since larger amounts of water need to be removed in the subsequent process steps, thus making the process according to the invention more costly.

The present invention thus also provides a process where the amount of the water added in process step b) is 1 to 100 parts by weight of water based on one part by weight of the polyamide present in the melt.

The temperature of the water added in process step b) may be varied over wide limits. Generally the temperature of the water added in process step b) is in the range from 20 to <170° C., preferably in the range from 20 to 160° C., particularly preferably in the range from 50 to 150° C. and especially preferably in the range from 60 to 145° C., wherein the addition of water is effected only after reaching or going below the cloud temperature (T_{Cl}).

The present invention thus also provides a process where the addition of water in process step b) is effected at a temperature in the range from 20 to <170° C. and after reaching or going below the cloud temperature (T_{Cl}).

In a preferred embodiment process step b) is performed under pressure to avoid evaporation of the water added in process step b). For example, a sealed reactor, for example an autoclave, may be employed to this end. In a preferred embodiment process step b) too is performed with agitation. Since process step a) and b) are preferably performed in the same reactor the remarks and preferences mentioned in connection with process step a) apply correspondingly to the reactors.

The present invention thus also provides a process where process step a) and b) are performed in the same reactor.

After addition of water process step b) affords a suspension which comprises the polyamide powder suspended in a solution of water and the lactam.

Process Step c)

The polyamide powder obtained in the form of a suspension in process step b) may be removed in process step c). This removal of the polyamide powder is effected by processes known per se to those skilled in the art, for example filtration or centrifugation. The polyamide powder is thus removed from the solution comprising water and the lactam in process step c). The thus obtained polyamide powder may optionally be worked up further. In a preferred embodiment the polyamide powder is washed with water to remove any residual lactam present from the polyamide powder. In a further preferred embodiment after the removal according to process step c) the polyamide powder is washed with water and then dried.

This drying may be a thermal drying. Preferred thermal drying processes are for example drying in a fluidized bed supplied with hot air or drying under a nitrogen atmosphere under reduced pressure at elevated temperatures, for example in the range from 50 to 100° C.

Polyamide Powder

The polyamide powders obtainable by the process according to the invention have a narrow grain size distribution (particle size distribution) and a very largely round shape. The so-called sphericity value (SPHT value) is used as a measure therefor. The sphericity value of the polyamide particles is given here by the ratio of the surface of the polyamide particles to the surface of ideal spheres of the same volume. The sphericity value may be determined by image analysis for example using a Camsizer.

The polyamide powders obtainable by the process according to the invention generally have a sphericity value in the range from 0.4 to 1.0.

The polyamide powders obtainable by the process according to the invention have a narrow particle size distribution.

The polyamide powders generally have

a D10 value in the range from 5 to 50 μm,

a D50 value in the range from 20 to 80 μm and

a D90 value of 40 to 150 μm

In a preferred embodiment the polyamide powders have

a D10 value in the range from 10 to 40 μm,

a D50 value in the range from 30 to 70 μm and

a D90 value of 45 to 130 μm

The present invention thus also provides a process where the polyamide powder obtained according to process step c) has

a D10 value in the range from 5 to 50 μm,

a D50 value in the range from 20 to 80 μm and

a D90 value in the range from 40 to 150 μm

In the context of the present invention “D10 value” is in this connection to be understood as meaning the particle size at which 10 vol % of the particles based on the total volume of the particles are smaller than/equal to the D10 value and 90 vol % of the particles based on the total volume of the particles are larger than the D10 value. By analogy, the D50 value is to be understood as meaning the particle size at which 50 vol % of the particles based on the total volume of the particles are smaller than/equal to the D50 value and 50 vol % of the particles based on the total volume of the particles are larger than the D50 value. By analogy, the D90 value is to be understood as meaning the particle size at which 90 vol % of the particles based on the total volume of the particles are smaller than/equal to the D90 value and 10 vol % of the particles based on the total volume of the particles are larger than the D90 value.

To determine the sphericity value and the particle sizes the polyamide powder obtained in process step b) is analyzed in the form of the suspension obtained in process step b). The D10, D50 and D90 values are determined by laser diffraction using a Malvern Mastersizer 3000. Evaluation was by Fraunhofer diffraction.

A measure of the width of the particle size distribution is the difference between the D90 value and the D10 value (D90 value minus D10 value). The closer these two values are to one another, i.e. the smaller the difference, the narrower the particle size distribution.

The polyamide powders obtainable by the process according to the invention generally have values for the difference between the D90 value and the D10 value in the range from 25 to 110 μm, preferably in the range from 10 to 50 μm.

A further measure of the width of the particle size distribution is the so-called span. The span is defined as (D90−D10)/D50. The span of the polyamide powder obtainable by the process according to the invention is generally in the range from 0.5 to 2.5, preferably in the range from 0.6 to 1.2.

The polyamide powders obtainable by the process according to the invention moreover exhibit small amounts of fine fraction and small amounts of coarse fraction. In accordance with the invention “fine fraction” is to be understood as meaning polyamide particles having a particle size of less than 10 μm. In accordance with the invention “coarse fraction” is to be understood as meaning polyamide particles having a particle size of greater than 130 μm.

Generally the polyamide powders obtainable by the process according to the invention comprise less than 5 wt %, preferably less than 4 wt % and especially preferably less than 2 wt % of fine fraction in each case based on the total weight of the polyamide powder.

Generally the polyamide powders obtainable by the process according to the invention comprise less than 5 wt %, preferably less than 4 wt % and especially preferably less than 2 wt % of coarse fraction in each case based on the total weight of the polyamide powder.

The polyamide powder obtainable by the process according to the invention is readily fluidizable on account of the narrow particle size distribution and the good sphericity values of said powder. In some cases the polyamide powder obtained by the process according to the invention may be subjected to further processing without further classification. In some cases removal of coarse/fine fraction by sieving or sifting is not necessary. This allows the process according to the invention to eschew complex and costly classification steps.

The present invention thus also provides the polyamide powders obtainable by the process according to the invention. The remarks made hereinabove in respect of the process for producing the polyamide powders and also the preferences recited there apply correspondingly to the polyamide powders.

On account of the aforementioned advantageous properties of the polyamide powders obtainable by the process according to the invention, said powders may be employed advantageously in coating processes and in processes for sintering, preferably for laser sintering.

The present invention thus also provides for the use of the polyamide powders according to the invention in coating processes, preferably powder coating processes.

The present invention further provides for the use of the polyamide powders according to the invention in processes for sintering, preferably in processes for laser sintering.

The present invention thus also provides for the use of the polyamide powder obtainable by the process according to the invention as sintering powder in a process for producing molded articles by selective laser sintering.

The present invention is more particularly elucidated by the examples which follow without, however, limiting said invention thereto.

### EXAMPLE 1

40 g of polyamide 6 having a viscosity number of 144 ml/g and 160 g of ε-caprolactam were initially charged into a 1 L four-necked flask fitted with an internal thermometer. The mixture was then inertized with nitrogen and heated to 190° C. (internal temperature) with stirring. After four hours, a melt which comprised the polyamide 6 fully dissolved in the ε-caprolactam was obtained. The melt was subsequently cooled to a temperature lower than the cloud temperature (T_{Cl}). The flask contents solidified at an internal temperature of 125° C. 300 mL of deionized water (DI water) were then added to dissolve the ε-caprolactam. The flask contents were stirred here at 100 rpm. A suspension comprising the polyamide powder suspended in a solution comprising water and the ε-caprolactam was obtained. The polyamide powder was subsequently removed by means of a pressure filter (Seitz-Filter T1500) and washed with water and subsequently dried for 16 hours at 80° C. under a nitrogen atmosphere in a vacuum drying cabinet.

The polyamide powder had a D10 value of 24.0 μm, a D50 value of 62.7 μm and a D90 value of 129 μm.

The particle size distribution was determined by laser diffraction with a Malvern Mastersizer 3000. Evaluation was by means of Fraunhofer diffraction.

### EXAMPLE 2

18.5 g of polyamide 6 having a viscosity number of 144 ml/g and 166.5 g of ε-caprolactam were initially charged into a pressure reactor and inertized with nitrogen. This mixture was subsequently heated with stirring to 190° C. (internal temperature) to obtain a melt which comprised the polyamide 6 fully dissolved in the ε-caprolactam. In a second pressure cylinder 185 ml of DI water were heated to 140° C. After 4.5 hours the melt was slowly cooled to a temperature below the cloud temperature (T_{Cl}). The external temperature of the pressure reactor was 145° C. The internal temperature was determined via a temperature sensor and was 140.8° C. The internal temperature of the pressure reactor subsequently increased slightly. This is attributable to the onset of crystallization of the polyamide 6. Directly after detection of the temperature increase the water preheated in the second pressure cylinder was supplied to the pressure reactor with stirring. The thus obtained suspension was stirred for 30 minutes. The mixture was subsequently cooled to room temperature (20° C.) and the obtained polyamide powder removed, worked up and analyzed as described hereinabove in connection with example 1.

The thus obtained polyamide powder had a D10 value of 22 μm, a D50 value of 38 μm and a D90 value of 60 μm.

The particle size distribution was determined by laser diffraction with a Malvern Mastersizer 3000. Evaluation was by means of Fraunhofer diffraction.

### EXAMPLE 3

166.5 g of ε-caprolactam was initially charged into a pressure reactor having an internal thermometer and inertized with nitrogen. The ε-caprolactam was then melted by heating to 120° C. 18.5 g of polyamide 6 having a viscosity number of 120 ml/g and 0.69 g of Ultrabatch (40% nigrosine, 60% polyamide 6) were added with stirring to the ε-caprolactam melt and the mixture was subsequently heated to 190° C. (internal temperature) over 5 hours to obtain a melt which comprised the polyamide 6 fully dissolved in the ε-caprolactam.

In a second pressure cylinder 185 ml of DI water were heated to 170° C. The melt was slowly cooled to a temperature below the cloud temperature (T_{Cl}). The external temperature of the pressure reactor was 132° C. The internal temperature was 132.8° C. The mixture was held at this temperature for 10 minutes. 30 seconds after an increase in the internal temperature of the pressure reactor was detected the water preheated in the second pressure cylinder was supplied to the pressure reactor with stirring. The thus obtained suspension was subsequently reheated to 170° C. (internal temperature). After 10 minutes the mixture was cooled to room temperature (20° C.) with stirring and the obtained polyamide powder removed, worked up and analyzed as described hereinabove in connection with example 1.

The thus obtained polyamide powder had a D10 value of 37.2 μm, a D50 value of 63.2 μm and a D90 value of 104.5 μm.

The particle size distribution was determined by laser diffraction with a Malvern Mastersizer 3000. Evaluation was performed by means of Fraunhofer diffraction.

### EXAMPLE 4

166.5 g of ε-caprolactam was initially charged into a pressure reactor having an internal thermometer and inertized with nitrogen. The ε-caprolactam was then melted by heating to 120° C. 18.5 g of polyamide 6 having a viscosity number of 120 ml/g and 0.69 g of Ultrabatch (40% nigrosine, 60% polyamide 6) were added to the ε-caprolactam melt with stirring and the mixture was subsequently heated to 190° C. (internal temperature) with stirring over 5 hours to obtain a melt which comprised the polyamide 6 fully dissolved in the ε-caprolactam.

In a second pressure cylinder 185 ml of DI water were heated to 20° C. The melt was slowly cooled to a temperature below the cloud temperature (T_{Cl}). The external temperature of the pressure reactor was 130° C. The internal temperature was 130.3° C. 2 minutes after an increase in the internal temperature of the pressure reactor was detected the water preheated in the second pressure cylinder was supplied to the pressure reactor with stirring. The thus obtained suspension was subsequently cooled to room temperature (20° C.) with stirring and the obtained polyamide powder removed, worked up and analyzed as described hereinabove in connection with example 1.

The thus obtained polyamide powder had a D10 value of 19.4 μm, a D50 value of 33.2 μm and a D90 value of 49.2 μm.

The particle size distribution was determined by laser diffraction with a Malvern Mastersizer 3000. Evaluation was by means of Fraunhofer diffraction.

### EXAMPLE 5

166.5 g of ε-caprolactam was initially charged into a pressure reactor having an internal thermometer and inertized with nitrogen. The ε-caprolactam was then melted by heating to 120° C. 18.5 g of polyamide 6 having a viscosity number of 120 ml/g and 0.69 g of Ultrabatch (40% nigrosine, 60% polyamide 6) were added to the ε-caprolactam melt with stirring and the mixture was subsequently heated to 190° C. (internal temperature) over 5 hours to obtain a melt which comprised the polyamide 6 fully dissolved in the ε-caprolactam.

In a second pressure cylinder 185 ml of DI water were heated to 150° C. The melt was slowly cooled to a temperature below the cloud temperature (T_{Cl}). The internal temperature was 150° C. Before an increase in the internal temperature of the pressure reactor was detected the water preheated in the second pressure cylinder was supplied to the pressure reactor with stirring. The thus obtained suspension was subsequently cooled to room temperature (20° C.) with stirring and the obtained polyamide powder 0.30 removed, worked up and analyzed as described hereinabove in connection with example 1.

The thus obtained polyamide powder had a D10 value of 30.2 μm, a D50 value of 57.6 μm and a D90 value of 100.4 μm.

The particle size distribution was determined by laser diffraction with a Malvern Mastersizer 3000. Evaluation was performed by means of Fraunhofer diffraction.

1.-12. (canceled)

13. A process for producing polyamide powder comprising the process steps of
a) heating a mixture comprising a polyamide and a lactam to a temperature greater than a cloud temperature (T_{Cl}) above which the polyamide is fully dissolved in the lactam to obtain a melt which comprises the polyamide fully dissolved in the lactam,
b) cooling the melt obtained in process step a) to a temperature lower than or equal to the cloud temperature (T_{Cl}) and subsequently adding water to obtain a suspension comprising the polyamide powder suspended in a solution comprising water and the lactam, and
c) removing the polyamide powder from the suspension obtained in process step b),
wherein
the lactam has a melting temperature (T_{M}) and the melt obtained in process step a) is cooled in process step b) to a temperature in the range from equal to the cloud temperature (T_{Cl}) to greater than the melting temperature (T_{M}) of the lactam and water is subsequently added, wherein the amount of the water added in process step b) is 1 to 100 parts by weight of water based on one part by weight of the polyamide present in the melt, wherein the polyamide powder obtained according to process step c) has a D10 value in the range from 5 to 50 μm,
a D50 value in the range from 20 to 80 μm and
a D90 value in the range from 40 to 150 μm.

14. The process according to claim 13, wherein in process step a) the mixture is heated to a temperature in the range from 170° C. to 250° C. to obtain the melt.

15. The process according to claim 13, wherein the addition of water in process step b) is effected at a temperature in the range from 20 to <170° C. and after reaching or going below the cloud temperature (T_{Cl}).

16. The process according to claim 13, wherein the polyamide has a crystallization temperature (T_{Cr}) and the melt obtained in process step a) is cooled in process step b) to a temperature in the range from equal to the cloud temperature (T_{Cl}) to not more than 20° C. below the crystallization temperature (T_{Cr}) of the polyamide and water is subsequently added.

17. The process according to claim 13, wherein the melt obtained in process step a) comprises the polyamide in amounts in the range from 5 to 60 wt % based on the total weight of the melt obtained in process step a).

18. The process according to claim 13, wherein the water content of the melt obtained in process step a) is in the range from 0 to less than 5 wt % based on the total weight of the melt obtained in process step a).

19. The process according to claim 13, wherein the lactam is selected from the group consisting of 3-aminopropanolactam, 4-aminobutanolactam, 5-aminopentanolactam, 6-aminohexanolactam, 7-aminoheptanolactam, 8-aminooctanolactam, 9-nonanolactam, 10-decanolactam, 11-undecanolactam, and 12-dodecanolactam.

20. The process according to claim 13, wherein the polyamide is selected from the group consisting of PA 4, PA 6, PA 7, PA 8, PA 9, PA 11, PA 12, PA 46, PA 66, PA 69, PA 610, PA 612, PA 613, PA 1212, PA1313, PA 6T, PA MXD6, PA 6l, PA 6-3-T, PA 6/6T, PA 6/66, PA 6/12, PA 66/6/610, PA 6l/6T, PA PACM 12, PA 6l/6 T/PACM, PA 12/MACMI, PA 12/MACMT, PA PDA-T and copolyamides formed from two or more of the abovementioned polyamides.

21. The process according to claim 13, wherein the melt present in process step a) comprises at least one anti-nucleation agent selected from the group consisting of lithium chloride, nigrosine, methylene blue and neutral red.

22. The process according to claim 13, wherein the anti-nucleation agent is added in process step a) in amounts such that the polyamide powder obtained according to process step c) comprises the anti-nucleation agent in amounts in the range from 0.1 to 3 wt % based on the total weight of the polyamide obtained according to process step c).

23. A polyamide powder obtainable by a process according to claim 13, wherein the polyamide powder comprises less than 5% by weight of fines, based on the total weight of the polyamide powder, wherein fines are understood to be polyamide particles having a particle size smaller than 10 μm.

24. A method comprising producing a molded article by selective laser sintering utilizing the polyamide powder obtained by the process according to claim 13 as sintering powder.
